(19) United States
(12) Patent Application Publication
(10) Pub. No.: US 2009/0262205 A1
(43) Pub. Date: Oct. 22, 2009

(54) Voice activated headset imaging system

(76) Inventor: Dana Stephen Smith, Dana Point, CA (US)

Correspondence Address: SHARP LABORATORIES OF AMERICA, INC., 1320 PEARL ST., SUITE 228, BOULDER, CO, 80302, US

(21) Appl. No.: 12/148,632

(22) Filed: Apr. 21, 2008

(51) Int. Cl. H04N 5/232; H04N 5/225; H04N 7/18; H04N 9/47

(52) U.S. Cl. 348/211.4; 348/376; 348/370; 348/E05.043; 348/115; 396/420

(57) ABSTRACT

A voice activated headset imaging system and elements thereof enable hands-free imaging. Hands-free imaging in some embodiments of the invention comprises receiving by a headset assembly a voice command and executing by the headset assembly an imaging control instruction generated in response to the voice command. Execution of the imaging control instruction involves an operation such as activating an object pointer, capturing an image, deleting a captured image or downloading a captured image.

### BACKGROUND OF THE INVENTION

The present invention relates to imaging and, more particularly, to hands-free imaging.

Frequently, an individual in a mobile environment encounters visual information that he or she wants to record. A conventional way to record the visual information is to take a picture using a hand-held camera, which may be a conventional digital camera or a cellular phone camera.

Unfortunately, hand-held cameras cannot be used by individuals who do not have hands or who are afflicted by a neuromuscular disorder that causes involuntary hand movement. Moreover, using a hand-held camera in a mobile environment can be a time-intensive and clumsy practice. Before taking the picture, the camera must be powered-up or enabled. This requires pressing a button or a selector switch and may also require opening a clamshell assembly, all of which involve use of one and potentially both hands. The individual must also frame the object of interest. This requires that the individual move the camera or the object, or both, and possibly adjust a lens focus control by hand. The individual must also press the shutter button to capture the image, which is normally done by hand. Additional use of hands is often required to offload the captured image to a personal computer or server for processing and/or printing. These requirements leave hand-held cameras ill-suited to many real-world imaging applications, such as a research application where an individual wants to quickly image select pages of a manuscript that he or she is holding and reviewing or a security application where a government official wants to image passports of inbound travelers for rapid validation.

### SUMMARY OF THE INVENTION

The present invention, in a basic feature, provides a voice activated headset imaging system and elements thereof that enable hands-free imaging. The system is well suited to a mobile environment but can be used in a stationary (e.g. desktop) environment as well.

In one aspect of the invention, a headset assembly for a voice activated headset imaging system comprises a head frame, a microphone assembly having microphone logic coupled with the head frame and a camera assembly having camera logic coupled with the head frame, wherein the camera logic is adopted to execute a control instruction generated in response to a voice command received by the microphone logic.

In some embodiments, the camera assembly has a camera and an adjustable arm and the camera is coupled with the head frame via the adjustable arm.

In some embodiments, the camera assembly has a camera and an object pointer coupled with the camera and the object pointer is directionally disposed to illuminate an object within a field of view of the camera.

In some embodiments, the headset assembly further comprises a wireless network interface adopted to transmit the voice command to a wireless handset and receive the control instruction from the wireless handset.

In some embodiments, the headset assembly further comprises a system on chip adapted to receive the voice command from the microphone logic, generate the control instruction and transmit the control instruction to the camera logic.

In some embodiments, execution of the control instruction awakens the camera assembly from a power-saving state.

In some embodiments, execution of the control instruction causes the camera assembly to enter a power-saving state.

In some embodiments, execution of the control instruction activates the object pointer.

In some embodiments, execution of the control instruction captures an image within a field of view of the camera.

In some embodiments, execution of the control instruction deletes a captured image.

In some embodiments, execution of the control instruction downloads an image from the camera assembly to the wireless handset.

In some embodiments, execution of the control instruction captures an image within a field of view of the camera and downloads the image from the camera assembly to the wireless handset for processing and emailing to a predetermined address.

In another aspect of the invention, a wireless handset for a voice activated headset imaging system comprises a processor and a wireless network interface communicatively coupled with the processor, wherein the wireless handset receives from a headset assembly via the wireless network interface a voice command and in response to the voice command under control of the processor generates and transmits to the headset assembly via the wireless network interface an imaging control instruction.

In some embodiments, the wireless handset further receives from the headset assembly via the wireless network interface an image and under control of the processor stores the image on the wireless handset.

In some embodiments, the wireless handset further receives from the headset assembly via the wireless network interface an image and under control of the processor enhances the image.

In some embodiments, the wireless handset further receives from the headset assembly via the wireless network interface an image and under control of the processor routes the image to a predetermined address.

In yet another aspect of the invention, a method for hands-free imaging in a mobile environment comprises the steps of receiving by a headset assembly a voice command and executing by the headset assembly an imaging control instruction generated in response to the voice command.

In some embodiments, the method further comprises the steps of transmitting by the headset assembly via a wireless network interface the voice command and receiving by the headset assembly via the wireless network interface the imaging control instruction.

In some embodiments, execution of the imaging control instruction involves at least one operation selected from the group consisting of activating an object pointer, capturing an image, deleting a captured image and downloading a captured image.

In some embodiments, the method further comprises the step of executing by the headset assembly an audio control instruction to output status information on the voice command.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a voice activated headset imaging system.

FIG. 2 is a physical representation of the headset assembly of FIG. 1.

FIG. 3 is a functional representation of the headset assembly of FIG. 1.

FIG. 4 is a functional representation of the wireless handset of FIG. 1.

FIG. 5 shows software elements of the wireless handset of FIG. 1.

FIG. 6 shows a method for hands-free imaging in a mobile environment.

FIG. 7 is a functional representation of a headset assembly in alternative embodiments of the invention.

### DETAILED DESCRIPTION OF A PREFERRED EMBODIMENT

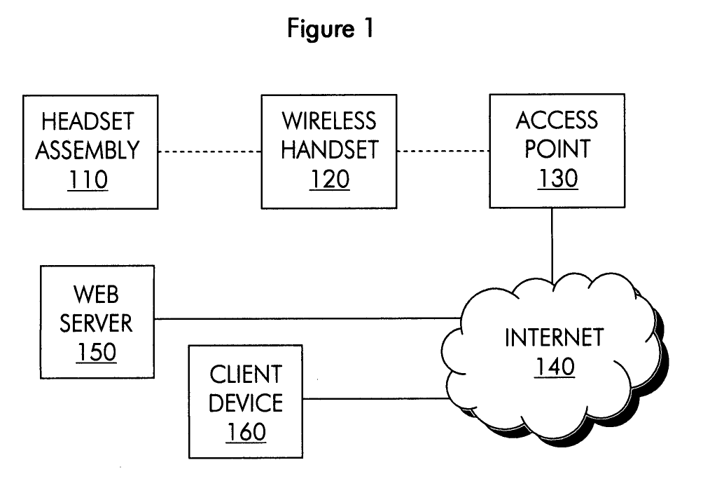

FIG. 1 shows a voice activated headset imaging system. In the system, a headset assembly 110 is communicatively coupled via a wireless link with a wireless handset 120, such as a cellular phone or personal data assistant (PDA). Wireless handset 120 is in turn communicatively coupled via a wireless link with an access point 130, such as a cellular base station or an Institute of Electrical and Electronics Engineers (IEEE) 802.11 wireless access point. Access point 130 is in turn communicatively coupled to a web server 150 and a client device 160 via the Internet 140 over respective wired connections. Headset assembly 110 and wireless handset 120 communicate using a short-range wireless communication protocol, such as Bluetooth, Wireless Universal Serial Bus (USB) or a proprietary protocol. Wireless handset 120, access point 130, Web server 150 and client device 160 communicate using well-known standardized wired and wireless communication protocols.

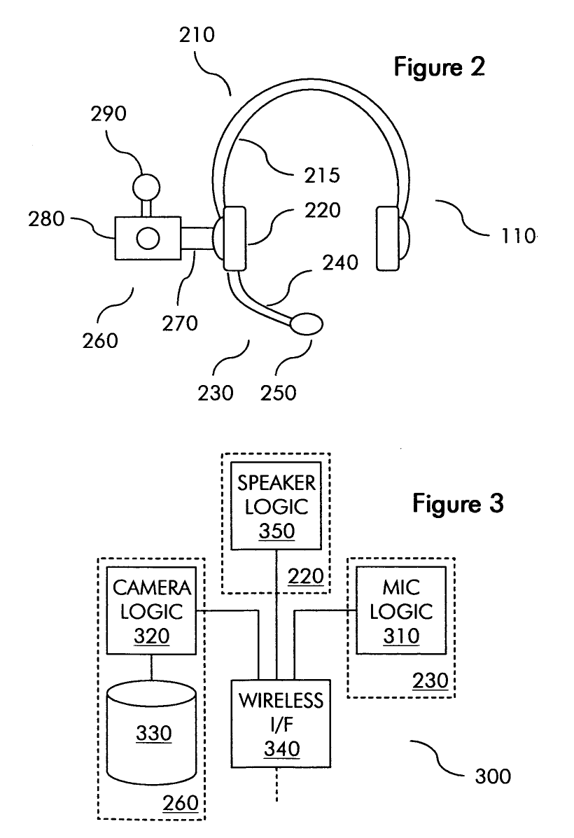

FIG. 2 shows headset assembly 110 in more detail. Headset assembly 110 includes a head frame 210 having a head bond 215 and two earpieces, one of which is earpiece 220. Head frame 210 is designed to be placed on the head of a human user with the earpieces on the ears of the user. Earpiece 220 outputs sound to the user. Coupled to earpiece 220 are a microphone assembly 230 and a camera assembly 260. Microphone assembly 230 includes a coupling arm 240 and a microphone 250. Coupling arm 240 connects microphone 250 to earpiece 220. Microphone 250 is designed to be placed near the mouth of the user wearing the headset assembly 110 and receive voice commands from the user. Camera assembly 260 includes an adjustable arm 270, a camera 280 and an object pointer 290. Adjustable arm 270 connects camera 280 to earpiece 220 in a manner that enables the field of view of camera 280 to be adjusted upward, downward, leftward and rightward without disconnecting camera 280 from earpiece 220. Adjustable arm 270 enables sufficient freedom of adjustment to ensure that the field of view of camera 280 can include an object being held by the user while avoiding the head, hair and eyewear of the user. Camera 280 captures images within its present field of view and performs other imaging operations in response to imaging control instructions generated in response to voice commands spoken by the user into microphone 250. Object pointer 290 is connected to the top of camera 280 and when powered-on emits a focused beam of light. Object pointer 290 is directionally disposed to illuminate objects within the present field of view of camera 280 and thereby inform the user whether directional adjustment of camera 280 is required to capture an object of interest. The focused beam of light emitted by object pointer 290 can also improve the contrast of the captured image. Object pointer 290 may be implemented using a laser or a blue or white light emitting diode (LED) illuminator, for example.

Head frame 120 has been illustrated as a sealed head frame that represents a particularly robust type of head frame that provide sonic isolation and a high degree of structural stability. In other embodiments, an open-air head frame may be employed that has smaller over-the-ear earpieces held in place by a light head band that allow the user's ears to remain partially exposed to the ambient environment and provides a high degree of comfort over an extended period of use. In still other embodiments, an earbud-type head frame may be used in which the earpieces fit into the outer ear of the user and are held in place by a light head band or attachment clips. In still other embodiments, a canal-type head frame may be used in which the earpieces fit into the user's ear canals and are held in place by a light head band or attachment clips.

FIG. 3 shows functional elements 300 of headset assembly 110 to include microphone logic 310, camera logic 320 and speaker logic 350 communicatively coupled with a wireless network interface 340. Microphone logic 310 includes an audio transducer for detecting voice commands spoken by a user who is wearing headset assembly 110 and microphone support circuitry for digitizing and transmitting voice commands to wireless handset 120 via wireless interface 340 for interpretation and processing. Camera logic 320 includes a lens and a two-dimensional photo imaging array bearing a color filter array for capturing images within its field of view and camera support circuitry. The camera support circuitry actuates image capture, writes/reads captured images to/from a camera image store 330, executes imaging control instructions received from wireless handset 120 via wireless interface 340 and provides status information regarding imaging control instructions and camera image store 330 to wireless handset 120 via wireless interface 340. In some embodiments, camera 280 is a complementary metal-oxide semiconductor (CMOS) camera having a rectangular image sensor whose long edge is oriented to align with the long side of a portrait-oriented document held at arm's length in front of the user. Speaker logic 350 includes a loudspeaker and speaker support circuitry. The speaker support circuitry drives the loudspeaker to emit predefined tones that inform the user about the status of voice commands (for example, whether voice commands have been understood and executed) and camera image store 330 (for example, whether camera image store 330 is full) in response to audio control instructions received from wireless handset 120 via wireless interface 340.

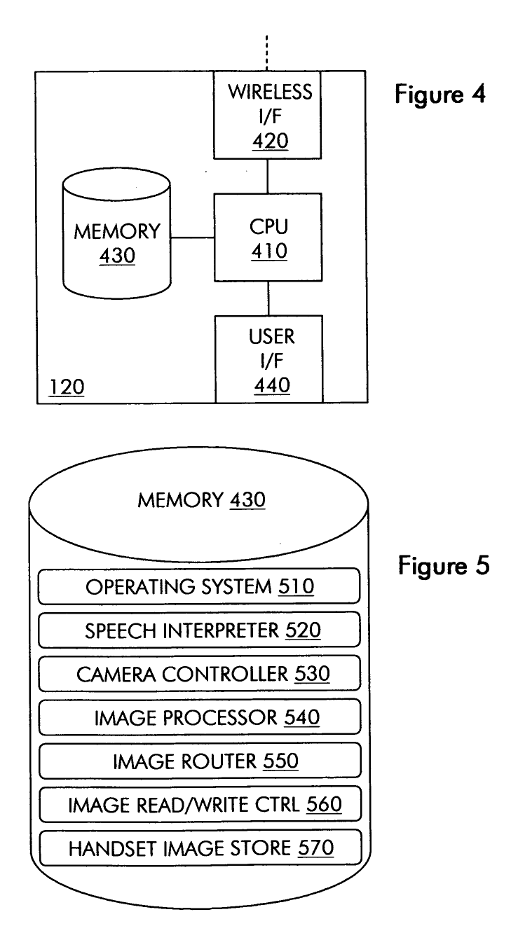

FIG. 4 shows functional elements of wireless handset 120 to include a wireless network interface 420, a memory 430 and a user interface 440 communicatively coupled with a processor (CPU) 410. Processor 410 executes software stored in memory 430 and interfaces with wireless interface 420 and user interface 440 to perform functions supported by wireless handset 120, including facilitating hands-free imaging in a mobile environment as described herein. In FIG. 5, software stored in memory 430 is shown to include an operating system 510, a speech interpreter 520, a camera controller 530, an imaging processor 540, an image router 550 and an image read/write controller 560. Operating system 510 manages and schedules execution of tasks by processor 410. Speech interpreter 520 interprets and classifies voice commands received from microphone logic 310 via wireless interface 420. Camera controller 530 generates imaging control instructions based on the classified voice commands and transmits the imaging control instructions to camera logic 320 via wireless interface 420. Camera controller 530 also generates audio control instructions based on status information received from camera logic 320 via wireless interface 420 and transmits the audio control instructions to speaker logic 350 via wireless interface 420. Image processor 540 enhances captured images downloaded from camera logic 320 via wireless interface 420. Such enhancements may include, for example, assembling multiple successive images captured by camera 280 into a single larger image or a single image with higher resolution, or compressing an image captured by camera 280 in preparation for routing of the image by image router 550 to a predetermined address. Image router 550 routes images captured and enhanced images downloaded by camera logic 320 via wireless interface 420 to Web server 150 or an email recipient on client device 160. Web server 150 may be, for example, an authentication server that attempts to validate an object displayed in the captured image, such as passport information, and returns a validation response to wireless handset 120 that may be displayed on user interface 440. Image read/write controller 560 writes/reads to/from handset image store 570 captured images downloaded from camera logic 320 via wireless interface 420, in some cases after such downloaded images have been enhanced by image processor 540. In some embodiments, wireless handset 120 is replaced by a wirelessly connected host computer that provides or emulates the functionality described herein as being performed by handset 120.

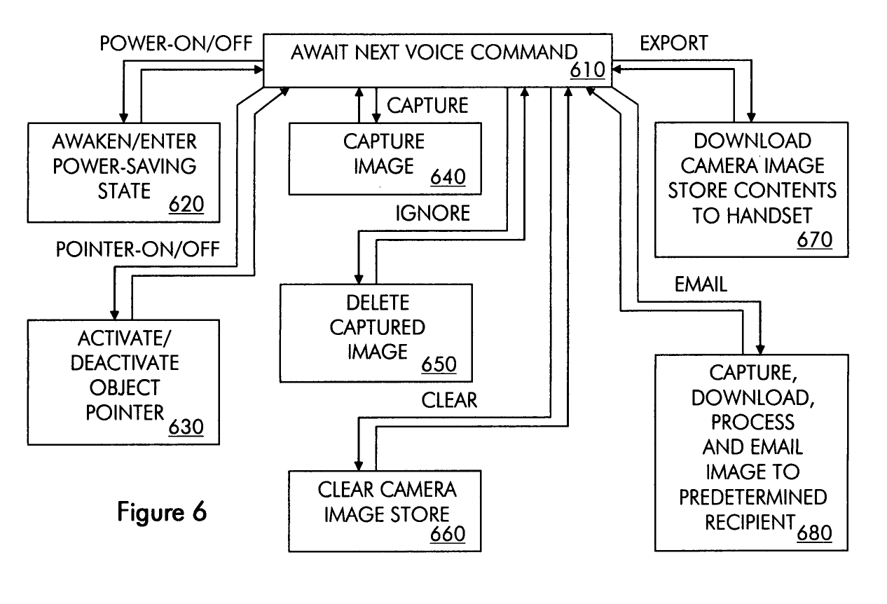

FIG. 6 shows a method for hands-free imaging in a mobile environment. The hands-free imaging system begins in a listening state wherein it awaits the next voice command spoken into microphone 250 by a user who is wearing headset assembly 110 (610). If the next voice command is a POWER-ON or POWER-OFF command, the system awakens from or enters, respectively, a power-conserving state (620) and returns to the listening state (610). To conserve battery power, headset assembly 110 in response to a POWER-OFF command, or automatically after a period of nonuse, enters a low power state in which the supply of power is inhibited to camera logic 320, wireless interface 340 and speaker logic 350. When microphone logic 310 receives a POWER-ON voice command while in the low power state, microphone logic 310 restores power to wireless interface 340 and transmits to wireless handset 120 via wireless interface 340 the voice command in digital form for interpretation and processing. In response to the POWER-ON voice command, wireless handset 120 generates and returns to microphone logic 310 via wireless interface 420 a control instruction that restores power to camera logic 320 and speaker logic 350. Similarly, when microphone logic 310 receives a POWER-OFF voice command while in the full power state, microphone logic 310 transmits to wireless handset 120 via wireless interface 340 the voice command in digital form to for interpretation and processing. In response to the POWER-OFF voice command, wireless handset 120 generates and returns to microphone logic 310 via wireless interface 420 a control instruction that inhibits power to camera logic 320 and speaker logic 350.

If the next voice command is a POINTER-ON or POINTER-OFF command, the system turns-on or turns-off, respectively, object pointer 290 (630) and returns to the listening state (610). When microphone logic 310 receives a POINTER-ON voice command, microphone logic 310 transmits to wireless handset 120 via wireless interface 340 the voice command in digital form for interpretation and processing. In response to the POINTER-ON voice command, wireless handset 120 generates and returns to camera logic 320 via wireless interface 420 a control instruction that camera logic 320 executes to activate object pointer 290. When microphone logic 310 receives a POINTER-OFF voice command, microphone logic 310 transmits to wireless handset 120 via wireless interface 340 the voice command in digital form for interpretation and processing. In response to the POINTER-OFF voice command, wireless handset 120 generates and returns to camera logic 320 via wireless interface 420 a control instruction that camera logic 320 executes to deactivate object pointer 290.

If the next voice command is a CAPTURE command, the system captures the image within the present field of view of camera 280 (640) and returns to the listening state (610). When microphone logic 310 receives a CAPTURE voice command, microphone logic 310 transmits to wireless handset 120 via wireless interface 340 the voice command in digital form for interpretation and processing. In response to the CAPTURE voice command, wireless handset 120 generates and returns to camera logic 320 via wireless interface 420 a control instruction that camera logic 320 executes to actuate image capture. The image capture actuated by the CAPTURE command may be one of single frame capture (i.e. still imaging), burst frame capture or sequential frame capture at a predetermined rate (i.e. full motion video). Where full motion video is captured, the system may also capture via microphone 250 and store audio synchronized with the full motion video. The full motion video and accompanying audio may be captured for a predetermined time, or may continue until a second voice command indicating to terminate image capture (e.g. STOP) is processed.

If the next voice command is an IGNORE command, the system deletes the most recently captured image (650) and returns to the listening state (610). When microphone logic 310 receives an IGNORE voice command, microphone logic 310 transmits to wireless handset 120 via wireless interface 340 the voice command in digital form for interpretation and processing. In response to the IGNORE voice command, wireless handset 120 generates and returns to camera logic 320 via wireless interface 420 a control instruction that camera logic 320 executes to delete from camera image store 330 the most recently captured image.

If the next voice command is a CLEAR command, the system deletes all images from camera image store 330 (660) and returns to the listening state (610). When microphone logic 310 receives a CLEAR voice command, microphone logic 310 transmits to wireless handset 120 via wireless interface 340 the voice command in digital form for interpretation and processing. In response to the CLEAR voice command, wireless handset 120 generates and returns to camera logic 320 via wireless interface 420 a control instruction that camera logic 320 executes to delete all images from camera image store 330.

If the next voice command is an EXPORT command, the system downloads to wireless handset 120 all images from camera image store 330 (670) and returns to the listening state (610). When microphone logic 310 receives an EXPORT voice command, microphone logic 310 transmits to wireless handset 120 via wireless interface 340 the voice command in digital form for interpretation and processing. In response to the EXPORT voice command, wireless handset 120 generates and returns to camera logic 320 via wireless interface 420 a control instruction that camera logic 320 executes to download to wireless handset 120 via wireless interface 340 all images presently stored in camera image store 330.

If the next voice command is an EMAIL command, the system performs a multifunction workflow operation in which an image is captured, downloaded, processed and emailed (680) before returning to the listening state (610). When microphone logic 310 receives an EMAIL voice command, microphone logic 310 transmits to wireless handset 120 via wireless interface 340 the voice command in digital form for interpretation and processing. In response to the EMAIL voice command, wireless handset 120 generates and returns to camera logic 320 via wireless interface 420 a control instruction that camera logic 320 executes to actuate image capture and download the captured image to wireless handset 120. Wireless handset 120 then performs image processing on the captured and downloaded image (e.g. compression) and emails the image to a predetermined email address associated with client device 160.

Other imaging control instructions are possible. For example, in some embodiments a RECORD command is supported that when received by microphone logic 310 causes the system to store in camera store 330 in association with a recently captured still image audio information spoken into microphone 250 by the user. The RECORD command can be invoked to add voice annotation to the still image.

In addition to processing imaging control instructions, the system is operative to execute audio control instructions. Camera logic 320 transmits to wireless handset 120 via wireless interface 340 periodic or event-driven status information in response to which wireless handset 120 issues audio control instructions to speaker logic 350 that speaker logic 350 executes to inform the user via audible output on the loudspeaker of the status of voice commands and camera image store 330. Such audible output may, for example, notify the user that a voice command was or was not understood or has or has not been carried-out, or that camera image store 330 is at or near capacity. Such audible output may be delivered in the form of predefined tones or prerecorded messages, for example.

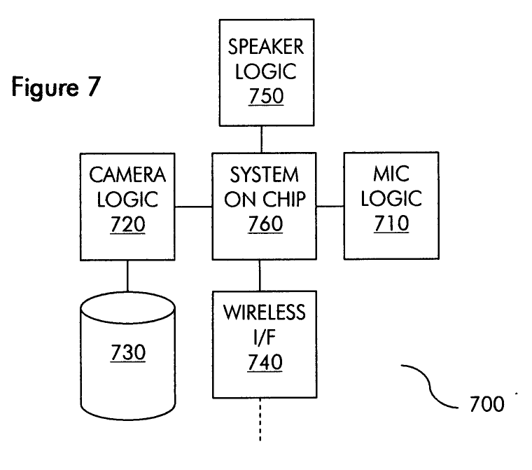

FIG. 7 shows functional elements 700 of a headset assembly in alternative embodiments of the invention. In these embodiments, speech interpretation and camera control are performed in custom circuitry and/or software by a system on chip 760 on the headset assembly. Basic system operations (e.g. power-on/off, pointer on/off, capture, ignore, clear) can thus be performed by the headset assembly without connectivity to a wireless handset, allowing the headset assembly to perform these operations even when a wireless handset is not in range. System on chip 760 is communicatively coupled with microphone logic 710, camera logic 720 (which has an associated camera image store 730), speaker logic 750 and wireless network interface 740. System on chip 760 may reside, for example, in an earpiece of the headset assembly. Microphone logic 710 includes an audio transducer for detecting voice commands spoken by a user wearing the headset assembly and microphone support circuitry for digitizing the voice commands and transmitting the voice commands to system on chip 760 for interpretation and processing. Camera logic 720 has a lens and a two-dimensional photo imaging array bearing a color filter array for capturing images within its field of view and camera support circuitry. The camera support circuitry actuates image capture, writes/reads captured images to/from a camera image store 730, executes imaging control instructions received from system on chip 760 and provides to system on chip 760 status information regarding imaging control instructions and camera image store 630. Speaker logic 650 includes a loudspeaker and speaker support circuitry. The speaker support circuitry drives the loudspeaker to emit predefined tones that inform the user about the status of voice commands and camera image store 730 in response to audio control instructions received from system on chip 760. System on chip 760 has a speech interpreter that interprets and classifies voice commands received from microphone logic 710 and a camera controller that generates imaging control instructions based on the classified voice commands and transmits the imaging control instructions to camera logic 720. The camera controller also generates audio control instructions based on status information received from camera logic 720 and transmits the audio control instructions to speaker logic 750. System on chip 760 also has a wireless communication processor that interfaces with a wireless handset via wireless interface 740 to offload images from camera image store 730 to the wireless handset for processing, storage and/or routing. In some embodiments, elements of microphone logic 710, camera logic 720 and speaker logic 750 may be operative within system on chip 760.

It will be appreciated by those of ordinary skill in the art that the invention can be embodied in other specific forms without departing from the spirit or essential character hereof. For example, in other embodiments, a headset assembly includes dual cameras and an object is imaged by the two cameras simultaneously. The image pairs are used to compute depth information, or increase the effective imaging area and/or effective imaging resolution. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A headset assembly for a voice activated headset imaging system, comprising:
a head frame;
a microphone assembly having microphone logic coupled with the head frame; and
a camera assembly having camera logic coupled with the head frame, wherein the camera logic is adapted to execute a control instruction generated in response to a voice command received by the microphone logic.

2. The headset assembly of claim 1, wherein the camera assembly has a camera and an adjustable arm and wherein the camera is coupled with the head frame via the adjustable arm.

3. The headset assembly of claim 1, wherein the camera assembly has a camera and an object pointer coupled with the camera and wherein the object pointer is directionally disposed to illuminate an object within a field of view of the camera.

4. The headset assembly of claim 1, further comprising a wireless network interface adapted to transmit the voice command to a wireless handset and receive the control instruction from the wireless handset.

5. The headset assembly of claim 1, further comprising a system on chip adapted to receive the voice command from the microphone logic, generate the control instruction and transmit the control instruction to the camera logic.

6. The headset assembly of claim 1, wherein execution of the control instruction awakens the camera assembly from a power-saving state.

7. The headset assembly of claim 1, wherein execution of the control instruction causes the camera assembly to enter a power-saving state.

8. The headset assembly of claim 1, wherein the camera assembly has a camera and execution of the control instruction activates an object pointer directionally disposed to illuminate an object within a field of view of the camera.

9. The headset assembly of claim 1, wherein the camera assembly has a camera and execution of the control instruction captures an image within a field of view of the camera.

10. The headset assembly of claim 1, wherein the camera assembly has a camera and execution of the control instruction deletes an image captured by the camera.

11. The headset assembly of claim 1, wherein the camera assembly has a camera and execution of the control instruction downloads to a wireless handset an image captured by the camera.

12. The headset assembly of claim 1, wherein the camera assembly has a camera and execution of the control instruction captures an image within a field of view of the camera and downloads the image from the camera assembly to the wireless handset for processing and emailing to a predetermined address.

13. A wireless handset for a voice activated headset imaging system, comprising:
a processor; and
a wireless network interface communicatively coupled with the processor, wherein the wireless handset receives from a headset assembly via the wireless network interface a voice command and in response to the voice command under control of the processor generates and transmits to the headset assembly via the wireless network interface an imaging control instruction.

14. The wireless handset of claim 13, wherein the wireless handset further receives from the headset assembly via the wireless network interface an image and under control of the processor stores the image on the wireless handset.

15. The wireless handset of claim 13, wherein the wireless handset further receives from the headset assembly via the wireless network interface an image and under control of the processor enhances the image.

16. The wireless handset of claim 13, wherein the wireless handset further receives from the headset assembly via the wireless network interface an image and under control of the processor routes the image to a predetermined address.

17. A method for hands-free imaging, comprising the steps of:
receiving by a headset assembly a voice command; and
executing by the headset assembly an imaging control instruction generated in response to the voice command.

18. The method of claim 17, further comprising the steps of:
transmitting by the headset assembly via a wireless network interface the voice command; and
receiving by the headset assembly via the wireless network interface the imaging control instruction.

19. The method of claim 17, wherein execution of the imaging control instruction comprises capturing an image by the headset assembly.

20. The method of claim 17, further comprising the step of executing by the headset assembly an audio control instruction to output status information on the voice command.
